(19) United States
(12) Patent Application Publication
(10) Pub. No.: US 2009/0040651 A1
(43) Pub. Date: Feb. 12, 2009

(54) DISC APPARATUS AND METHOD OF STORING SERVO INFORMATION ON DISC MEDIUM

(75) Inventors: Fumiya Kudo, Kawasaki (JP); Mitsuo Kamimura, Kawasaki (JP); Masaaki Mitsui, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/168,491

(22) Filed: Jul. 7, 2008

(30) Foreign Application Priority Data
Aug. 9, 2007 (JP) 2007-208283

(51) Int. Cl. G11B 5/58

(52) U.S. Cl. 360/77.01

(57) ABSTRACT

According to an aspect of an embodiment, a disc apparatus includes a medium being capable of storing data and including a plurality of sets of servo information, each set of the servo information having identification information, a head for writing data into and reading data from the medium, an actuator for supporting the head and a controller for controlling the actuator in reference to selected one of the sets of the servo information on the basis of the associated identification information so as to move the head to a target position of the medium.

### BACKGROUND

An aspect of the invention relates to storage discs each of which stores therein pieces of servo information used for positioning a head, servo-information writing methods, disc devices, and methods for manufacturing the disc devices. The present technique relates to a storage disc which stores therein pieces of servo information in accordance with recording/reproducing characteristics the relationship between a head and the storage disc, a method for writing the pieces of servo information, a disc device, and a method for manufacturing the disc device.

In disc devices such as magnetic discs, pieces of data are read from and written to desired tracks of discs using heads which are positioned in the desired tracks of the discs. The discs each have pieces of servo information recorded in tracks with predetermined intervals in a circumferential direction, and the pieces of servo information are read and decrypted using the heads so that pieces of positional information of the heads are obtained.

A process of writing pieces of servo information on a medium before the medium is inserted into such a disc device is called servo track writing (STW). When the servo track writing is performed, pieces of servo information to be used by the disc device are written to the medium. After the disc medium is inserted into the disc device, all tracks to be used are checked. When a decryption error of one of the pieces of servo information is detected in one of the tracks, the track is determined to be a defect track which is not available.

Techniques of the related art are disclosed in Japanese Laid-open Patent Publication No. 07-249276, Japanese Laid-open Patent Publication No. 09-180355 and Japanese Laid-open Patent Publication No. 2003-338147.

### SUMMARY

According to an aspect of an embodiment, a disc apparatus includes a medium being capable of storing data and including a plurality of sets of servo information, each set of the servo information having identification information, a head for writing data into and reading data from the medium, an actuator for supporting the head and a controller for controlling the actuator in reference to selected one of the sets of the servo information on the basis of the associated identification information so as to move the head to a target position of the medium.

### BRIEF DESCRIPTION OF THE DRAWINGS

FIG. 1 is a flowchart illustrating a process of a method for manufacturing a disc device according to an embodiment of the present technique;

FIG. 2 is a diagram illustrating a disc medium including pieces of servo information written thereto according to the embodiment of the present technique;

FIG. 3 is a diagram illustrating the disc medium shown in FIG. 2 in which a number of pieces of optimum servo information are selected among all the pieces of servo information;

FIG. 4 is a diagram illustrating a servo track writer which writes the pieces of servo information shown in FIG. 2;

FIG. 5 is a diagram illustrating a configuration of the disc device according to the embodiment of the present technique;

FIGS. 6A and 6B are flowcharts illustrating a process of measuring quality of servo information and a process of selecting one of a plurality of types of servo information;

FIGS. 7A and 7B are flowcharts illustrating the process of measuring quality of servo-information of FIGS. 6A and 6B (part 1);

FIG. 8 is a flowchart illustrating the process of measuring quality of servo-information of FIGS. 6A and 6B (part 2);

FIG. 9 is a diagram illustrating the process of measuring quality of servo-information of FIGS. 7A and 7B performed in offset positions;

FIG. 10 is a flowchart illustrating a process of calculating results of the process of measuring quality of servo-information performed in FIG. 8;

FIG. 11 is a diagram illustrating a measurement result storing table used in the process of FIG. 10;

FIG. 12 is a diagram illustrating zones which are units of the measurement;

FIG. 13 is the process of selecting one of a plurality of types of servo information of FIGS. 6A and 6B (part 1);

FIG. 14 is the process of selecting one of a plurality of types of servo information of FIGS. 6A and 6B (part 2);

FIG. 15 is a diagram illustrating a determination flag table used in the process of selecting one of a plurality of types of servo information described with reference to FIGS. 13 and 14;

FIGS. 16A and 16B are flowcharts illustrating a process of using selected pieces of servo information of FIG. 1 (part 1);

FIG. 17 is a flowchart illustrating a process of using selected pieces of servo information of FIG. 1 (part 2); and

FIG. 18 is a diagram illustrating a disc medium including pieces of servo information in the related art.

### DESCRIPTION OF THE PREFERRED EMBODIMENTS

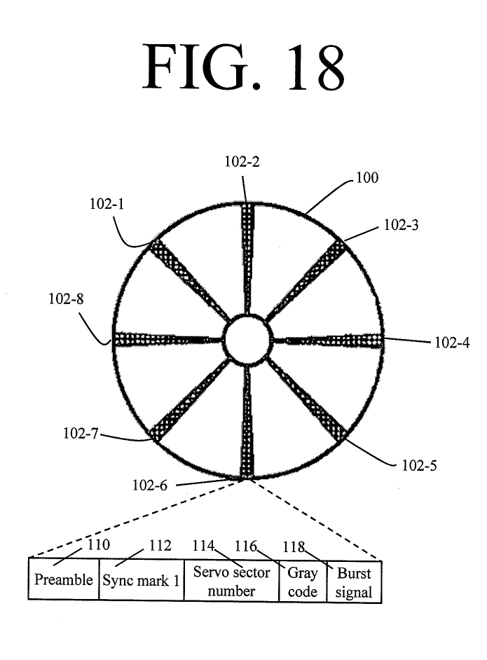

FIG. 18 is a diagram used to describe a servo track writing in the related art. Pieces of servo information 102-1 to 102-8 are written to a magnetic disc 100 with predetermined intervals in a circumferential direction. In the servo track writing in the related art, N (eight in FIG. 18) pieces of servo information 102-1 to 102-8 are written to the magnetic disc 100 so that the magnetic disc 100 is used in a disc device which requires N (eight in FIG. 18) pieces of servo information.

Each of the pieces of servo information 102-1 to 102-8 includes a preamble 110, a sync mark pattern 112 used for synchronization control, a servo sector number 114, a gray code 116 indicating a track position, and a burst signal 118 used for position control. A single or a plurality of sectors are arranged between the pieces of servo information 102-1 to 102-8. In the related art, the pieces of servo information 102-1 to 102-8 employ identical sync mark patterns.

In the related art, an identical writing parameter is used to write the pieces of servo information for each disc, and the writing parameter is determined in accordance with characteristics of each disc. Similarly, characteristics of pieces of servo information are identical for each disc in which the pieces of servo information are recorded by magnetic transfer.

An optimum value for the writing parameter used when the pieces of servo information are written depends on characteristics of a disc medium and a writing head. As a test process of a disc device before shipping, a head is positioned in accordance with the pieces of servo information and a read/write test is performed for individual tracks of a disc.

In this test, if the writing parameter does not coincide with the optimum value, a read error is likely to occur when the pieces of servo information are decrypted. When a read error is detected in one of the tracks, the track is determined to be a defect track which is not available, and accordingly, production yield is reduced.

In particular, when the magnetic disc device employs a perpendicular recording method in order to attain increased density, decryption quality of each of the pieces of servo information is considerably influenced by variation of characteristics of the disc medium since a range of the optimum value of the writing current in the perpendicular recording method is smaller than that in a horizontal recording method.

Therefore, the optimum value of the writing parameter should be adjusted when the characteristics of the disc medium are changed. However, the adjustment requires manual labor and time.

Furthermore, the optimum value of the writing parameter is varied due to variation of quality of the disc medium and variations of characteristics of the head for servo track writing. Therefore, when a fixed parameter is used to write the pieces of servo information, quality of the pieces of servo information varies.

A method for manufacturing a disc device, a servo-information writing method, a disc device, a servo-information measurement/selection process performed using the disc device, a process of measuring quality of servo-information, a servo-information evaluation/selection process, and a process of using servo-information according to an embodiment of the present technique, and other embodiments will be described hereinafter in this order with reference to the accompanying drawings. However, the present technique is not limited to these embodiments, and various modifications may be made.

### Method for Manufacturing Disc Device:

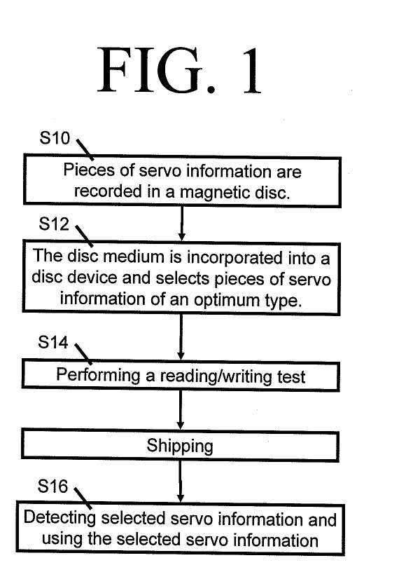

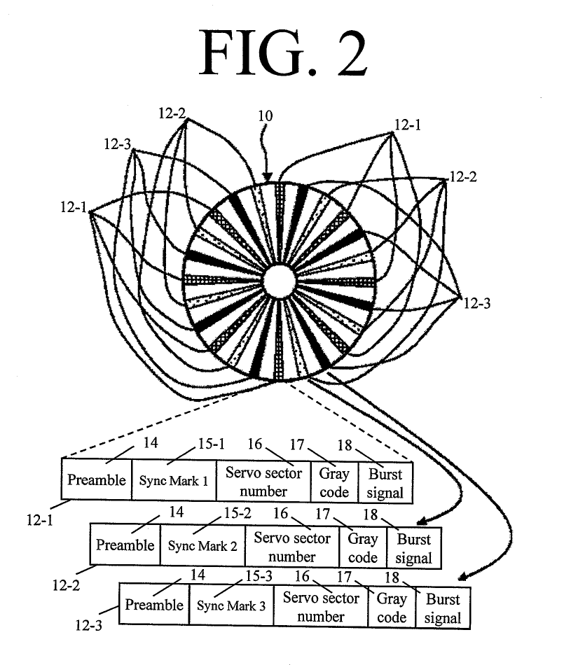

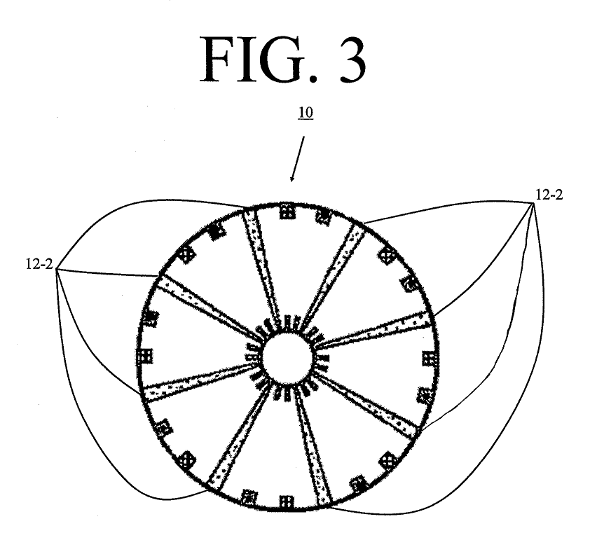

FIG. 1 is a flowchart illustrating a process of a method for manufacturing a disc device according to an embodiment of the present technique. FIG. 2 is a diagram illustrating a disc including pieces of servo information written thereto. FIG. 3 is a diagram illustrating the disc medium shown in FIG. 2 in which a number of pieces of optimum servo information are selected among all the pieces of servo information.

Referring to FIG. 1, a process of manufacturing a disc device will be described. Note that, a magnetic disc is taken as an example of the disc, and a magnetic disc device is taken as an example of the disc device herein.

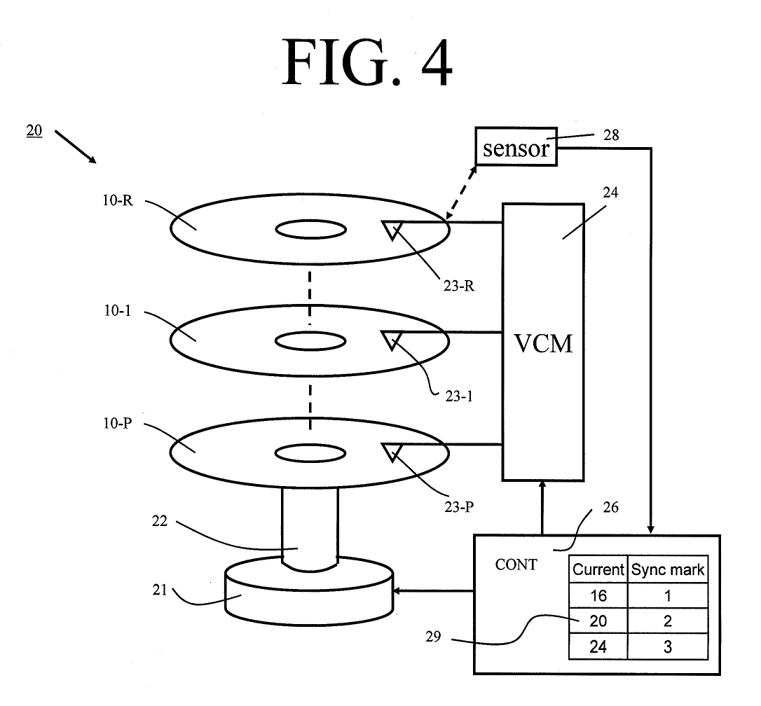

In step S10, pieces of servo information are recorded in a magnetic disc. As shown in FIG. 2, a servo track writer (refer to FIG. 4) writes M types of servo information each of which includes N pieces of servo information (M and N are integers and larger than 1) to a disc medium 10 in a circumferential direction while the disc rotates once so that the pieces of servo information are shifted relative to one another. Note that the disc medium 10 is to be used in a disc device which requires a disc medium having N pieces of servo information. M types of servo information have sync mark patterns different for each type so as to be distinguishable from each other. M types of servo information are written to the disc medium 10 using writing parameters (writing currents, for example) different from one another.

FIG. 2 shows one surface of the disc medium 10 to be employed in the disc device which requires eight pieces of servo information provided in one full circuit of the disc medium 10. Three types of servo information 12-1 to 12-3 are written to the disc medium 10 in a circumferential direction so that the three types of servo information each of which includes eight pieces of servo information are shifted relative to one another with predetermined intervals in the circumferential direction. Accordingly, each of the three types of servo information 12-1 to 12-3 is written to the disc medium 10 in the circumferential direction so as to be shifted from one another with predetermined intervals so that eight pieces of servo information are obtained for each type.

Formats of the three types of servo information 12-1 to 12-3 are identical. Each of the three types of servo information 12-1 to 12-3 includes a preamble 14 used to control a frequency, a phase, and an amplitude, a corresponding one of sync mark patterns 15-1 to 15-3 used for synchronization control, a servo sector number 16, a gray code 17 indicating a track position, and a burst signal 18 used for position control.

The three types of servo information 12-1 to 12-3 are written using writing currents different from one another and are written so as to have sync mark patterns 15-1 to 15-3 different from one another. For example, a first servo information 12-1 is written using a writing current of 16 mA and has a bit pattern of a sync mark of “00010100”, a second servo information 12-2 is written using a writing current of 20 mA and has a bit pattern of a sync mark of “00100100”, a third servo information 12-3 is written using a writing current of 24 mA and has a bit pattern of a sync mark of “101000100”.

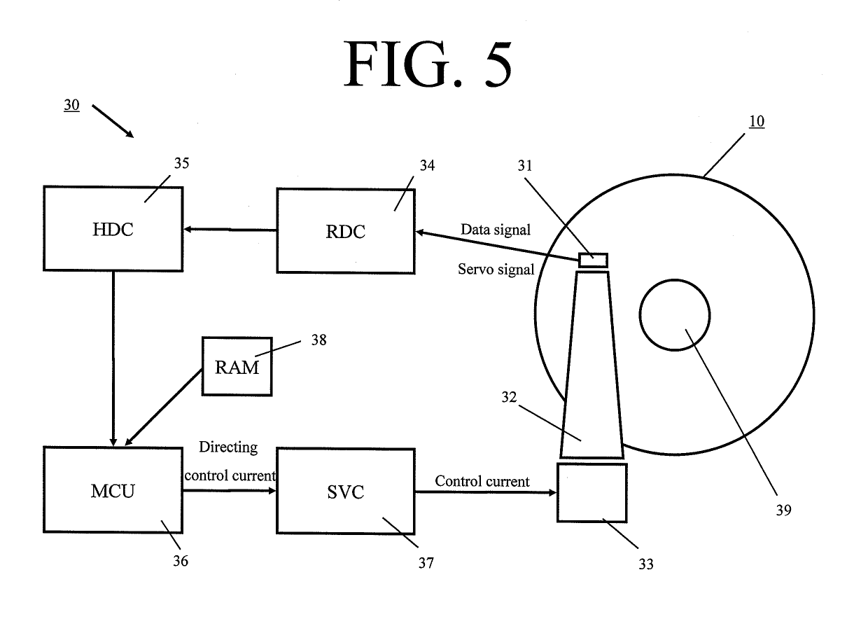

In step S12, the disc medium 10 including M types of servo information each of which includes N pieces of servo information written thereto is incorporated into (mounted in) a disc device 30, which will be described with reference to FIG. 5, to thereby facilitate assembly of the disc device 30. Then, the disc device 30 selects pieces of servo information of an optimum type. As will be described later, a head included in the disc device 30 which has been assembled is used to read the pieces of servo information from the disc medium 10, to measure qualities of the read pieces of servo information, and to select the pieces of optimum servo information in accordance with results of the measurements.

In step S14, the disc device 30 performs a reading/writing test using the selected pieces of servo information. In this reading/writing test, test patterns are written using heads to tracks other than regions in which the selected pieces of servo information are written, the written test patterns are read, and it is determined whether qualities of read/write operations satisfy a desired level. Accordingly, pieces of servo information which were not selected are removed by being replaced by the test patterns. As shown in FIG. 3, in a case where pieces of second servo information 12-2 are selected, pieces of first servo information 12-1 and pieces of third servo information 12-3 are replaced by the test patterns. Note that, in user areas which are not used and which are located in a region on the outer circumference side and a region on the inner circumference side of the disc medium 10, the pieces of first servo information 12-1 and the pieces of third servo information 12-3 which were not selected partially remain.

As described above, the optimum type of servo information is obtained for each head among the three types of servo information, and one of the sync mark patterns corresponding to the optimum type of servo information is stored in a nonvolatile ROM (Read-Only Memory) of the disc device 30 or a system area of the disc medium 10 for each head. Accordingly, in the disc device 30, the pieces of servo information of the optimum type are used as pieces of normal servo information used for positioning, and the regions in which pieces of servo information other than the pieces of normal servo information are written are used as user data regions. The pieces of servo information in the user data regions are overwritten with user data. Since the region on the inner circumference side and the region on the outer circumference side of the disc medium 10 are not used as the user data regions, even when writing of the user data to the entire disc medium 10 is attempted, the pieces of servo information other than the pieces of optimum servo information remain in the region on the inner circumference side and the region on outer circumference side of the disc medium 10.

In step S16, in a case where one of the sync mark patterns corresponding to the optimum type of servo information is stored in the system area of the disc medium 10, when the disc device 30 is first turned on after being shipped, information on the one of the sync mark patterns corresponding to the optimum type of servo information is not read. Therefore, the one of the sync mark patterns to be used to read the pieces of servo information of the optimum type is unknown. The nonvolatile ROM includes a table listing a plurality of types of sync mark patterns stored in advance. When each of the heads are loaded and a sync mark pattern is read, a sync-mark setting value of a read channel is successively replaced by a value read from the table listing the sync mark patterns whereby the pieces of servo information of the optimum type are read.

Since the pieces of servo information remain in the region on the inner circumference side and the region on the outer circumference side of the disc medium 10 as shown in FIG. 3, the remaining pieces of improper servo information may be read when the heads are loaded. To address this problem, only when values of gray codes (cylinder addresses or track addresses) are within a predetermined range (a range of a region in which the pieces of improper servo information do not remain), a mode in which the pieces of servo information are decrypted with predetermined intervals is entered. The disc device 30 is thus prevented from being locked due to the presence of the pieces of improper servo information. Accordingly, the disc device 30 which employs the disc medium 10 including the pieces of servo information can decrypt only the pieces of servo information of the optimum type without increasing processing time.

After the pieces of servo information are thus written to the disc medium 10 using different parameters and the disc medium 10 is mounted in the disc device 30, the heads included in the disc device 30 evaluate the qualities of the pieces of servo information, and the pieces of servo information of the optimum type are selected. Therefore, even when characteristics of the disc medium 10 and characteristics of the heads of the servo track writer are changed in quality, the heads of the disc device 30 maintain the pieces of servo information of the optimum type usable.

Furthermore, since the different sync mark patterns are assigned in order to allow the types of servo information to be distinguished between, the selected pieces of servo information can be distinguished between even after the disc device 30 is shipped, and furthermore, even if different types of servo information are selected between the surfaces of the disc medium 10 or among a plurality of disc media 10, the selected pieces of servo information can be readily used.

### Servo-Information Writing Method:

FIG. 4 is a diagram illustrating a servo track writer 20 which performs a servo-information writing process according to the embodiment of the present technique. As shown in FIG. 4, the servo track writer 20 includes a head moving motor (voice coil motor) 24 and a spindle motor 21. A plurality of magnetic heads 23-R and 23-1 to 23-P are attached to tip ends of arms of the head moving motor 24, and a reference disc 10-R and P object discs 10-1 to 10-P are attached to a rotation shaft 22 of the spindle motor 21. Each of the magnetic heads 23-R and 23-1 to 23-P faces one side of a corresponding one of the disc 10-R and 10-1 to 10-P.

The servo track writer 20 further includes an optical sensor 28 which optically detects a position of the magnetic head 23-R which faces the reference disc 10-R, a control circuit 26 which controls the head moving motor 24 to be located in a position detected using the optical sensor 28 and which supplies the pieces of servo information and applies writing currents to the magnetic heads 23-1 to 23-P so as to perform writing control.

The control circuit 26 has a table 29 listing the relationships between the writing currents used to write the three types of servo information 12-1 to 12-3 described above and the sync mark patterns. The reference disc 10-R includes timing signals written thereto.

Note that, although each of the magnetic discs 10-1 to 10-P has a corresponding one of the magnetic heads 23-1 to 23-P for simplicity in FIG. 4, each of the magnetic heads 23-1 to 23-P is constituted by a pair of magnetic heads facing opposing sides of corresponding two of the magnetic discs 10-1 to 10-P in practical use.

When the servo track writing is started, the spindle motor 21 rotates, and therefore, the magnetic discs 10-R and 10-1 to 10-P rotate. The timing signals read from the reference disc 10-R using the magnetic head 23-R are supplied to the control circuit 26. The optical sensor 28 detects a position of the magnetic head 23-R on the reference disc 10-R, and information on the detected position is supplied to the control circuit 26.

The control circuit 26 performs movement control (servo control) on the head moving motor 24 with reference to the position detected using the optical sensor 28, so that the magnetic heads 23-R and 23-1 to 23-P are located in desired positions, and supplies the writing currents and writing servo patterns (including the sync mark patterns) to the magnetic heads 23-1 to 23-P in accordance with the timing signals supplied from the magnetic head 23-R.

Then, the three types of servo information 12-1 to 12-3 described with reference to FIG. 2 are written to the both surfaces of each of the discs 10-1 to 10-P using specified writing currents. In general, since one surface of a magnetic disc has approximately ten thousands of tracks, positioning operations are performed on ten thousands of tracks, and the three types of servo information 12-1 to 12-3 described with reference to FIG. 2 are written to each of the tracks using the specified writing currents.

After pieces of servo information of the three types are written to all the tracks, the servo track writing is terminated. Then, the discs 10-1 to 10-P are detached from the rotation shaft 22 of the spindle motor 21. In this way, magnetic discs similar to the magnetic disc show in FIG. 2 in which the pieces of servo information have been written are generated.

### Disc Device:

FIG. 5 is a diagram illustrating a configuration of the disc device according to the embodiment of the present technique. In FIG. 5, components the same as those shown in FIGS. 2 and 3 are denoted by the reference numerals used in FIGS. 2 and 3. FIG. 5 shows the disc medium 10 shown in FIGS. 2 and 3 which is mounted on a rotation shaft 39 of a spindle motor and which is assembled with other components. In FIG. 5, a magnetic head 31 is constituted by a composite head which separately includes a read element and a write element.

The magnetic head 31 is attached to a tip end of an arm 32 of a VCM (Voice Coil Motor) 33. A read channel circuit 34 performs signal shaping on a signal read from a preamplifier (not shown) using the magnetic head (read element) 31, generates a synchronization clock and a gate signal, and outputs the read signal. Furthermore, the read channel circuit 34 supplies a write signal to the magnetic head (write element) 31.

A SVC (Servo Combo Circuit) 37 receives a driving instruction value supplied from an MCU (Micro Controller Unit) 36, and outputs a driving current in accordance with the driving instruction value so as to drive the VCM 33.

The MCU 36 includes an MPU (Micro Processor) and a servo controller, decrypts positional information obtained in accordance with the read signal output from the read channel circuit 34, detects a current position, and calculates the VCM driving instruction value in accordance with a difference between the detected current position and a target position. That is, the MCU 36 performs servo control including a seeking operation and a following operation. Furthermore, the MCU 36 analyzes commands, monitors a status of the disc device, and controls units included in the disc device.

A memory (RAM (Random Access Memory)) 38 stores data used in processes performed using the MCU 36. A hard disc controller (HDC) 35 communicates with a host. The HDC 35 receives read data from the read channel circuit 34 in accordance with the gate signal and the clock output from the read channel circuit 34, stores the read data in a buffer, and transmits the read data to the host. Furthermore, the HDC 35 supplies write data output from the host to the read channel circuit 34 in accordance with the gate signal and the clock supplied from the read channel circuit 34.

The HDC 35 communicates with the host via an IF (interface) such as a USB (Universal Serial Bus), an IDE (Integrated Drive Electronics), an ATA (AT Attached), or an SCSI (Small Computer System Interface).

In the configuration shown in FIG. 5, the HDC 35 communicates with the host and a drive so as to perform data transmission, the SVC 37 outputs the driving current so as to drive the VCM 33 so that the magnetic head 31 performs the seeking operation and the following operation, and the MCU 36 controls the seeking operation and the following operation and controls the units included in the disc device in accordance with commands received using the HDC 35.

In this embodiment, after the disc device 30 is assembled, the MCU 36 performs a servo-information selection process so that the disc medium 10 as shown in FIG. 3 is obtained. Then, when the disc device 30 is first turned on after being shipped, the selected pieces of servo information are searched for so as to be used for the servo control.

### Servo-Information Measurement/Selection Process Performed Using Disc Device:

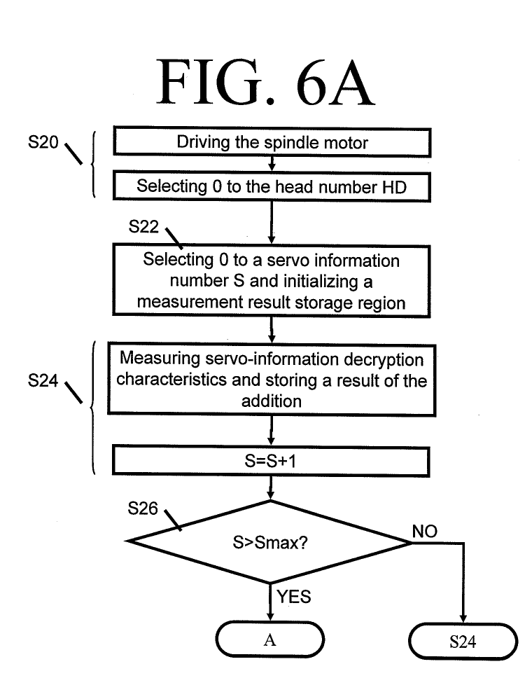

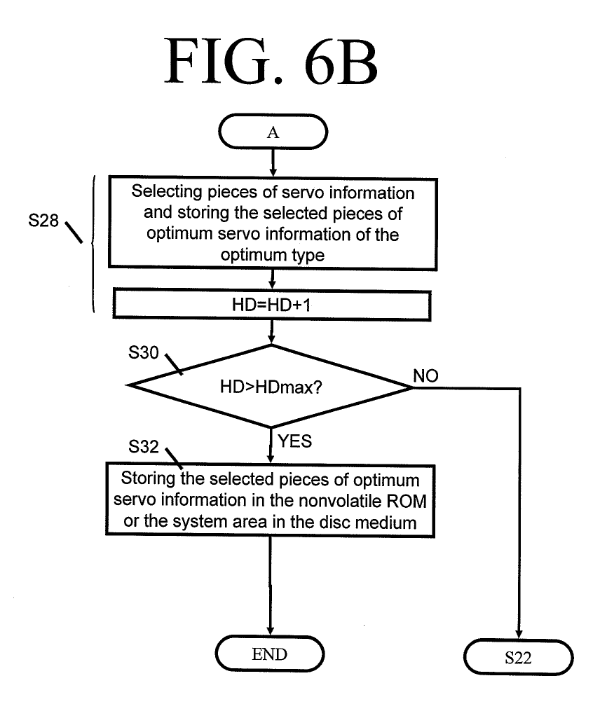

FIGS. 6A and 6B are flowcharts illustrating a process of measuring quality of servo information and a process of selecting one of types of servo information performed using the disc device according to the embodiment of the present technique. In FIGS. 6A and 6B, a servo information number “S” is assigned to one of the types of servo information, and a head number “HD” is assigned to one of the heads.

In step S20, the MCU 36 drives the spindle motor so as to rotate the disc medium 10. Then, the MCU 36 assigns (selects) 0 to the head number “HD”.

In step S22, the MCU 36 assigns (selects) 0 to a servo information number S, and initializes a measurement result storage region included in the RAM 38 by assigning “0” thereto.

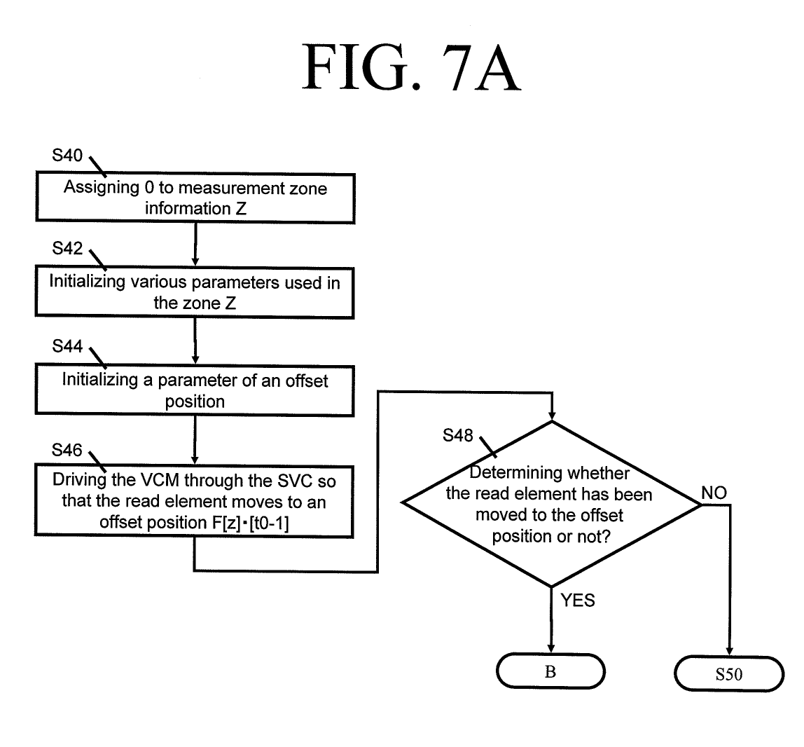

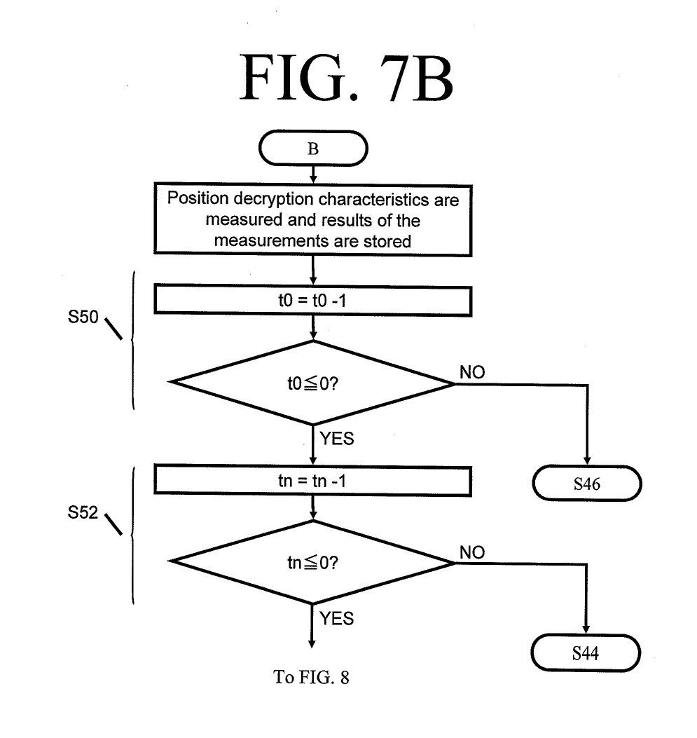

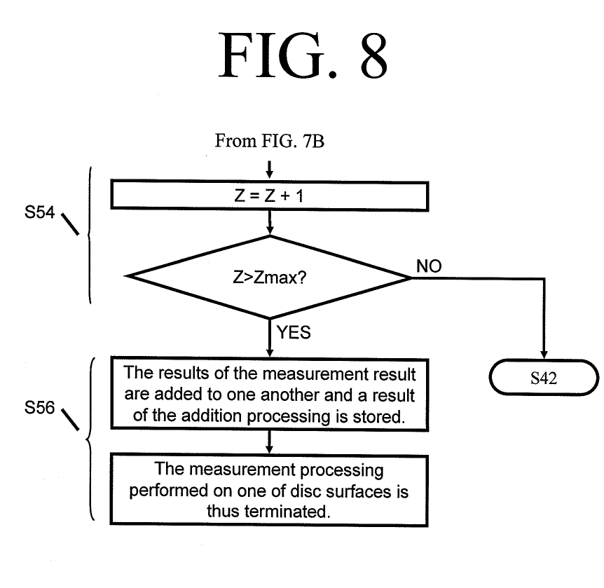

In step S24, the MCU 36 instructs the read channel circuit 34 to detect a sync mark corresponding to the servo information number S=0 (the first servo information 12-1, for example), and to perform a decryption operation. Accordingly, the read channel circuit 34 detects the sync mark corresponding to the servo information number S=0 (the first servo information 12-1, for example) from a signal read using the magnetic head (read element) 31 and decrypts pieces of servo information corresponding to the sync mark. The MCU 36 measures servo-information decryption characteristics in accordance with results of the decryptions, the results of the measurements are added to one another, and a result of the addition is stored in an addition-result storage region included in the RAM 38. The servo-information decryption characteristics includes, as will be described hereinafter with reference to FIGS. 7A and 7B, the number of sync-mark detection errors, the number of gray-code detection errors, an error of positional information obtained using a burst signal, and a signal amplitude factor. When measurement operations performed on desired tracks of the disc medium 10 are terminated, the MCU 36 increments the servo-information number S by one (S=S+1), that is, the second servo information 12-2 is specified.

In step S26, the MCU 36 determines whether the servo-information number S is larger than a value Smax (Smax=2 in FIG. 2) which is a maximum value of the servo-information number. When the determination is negative, the process returns to step S24, and servo-information decryption characteristics of pieces of servo information corresponding to one of the remaining next servo information number are measured.

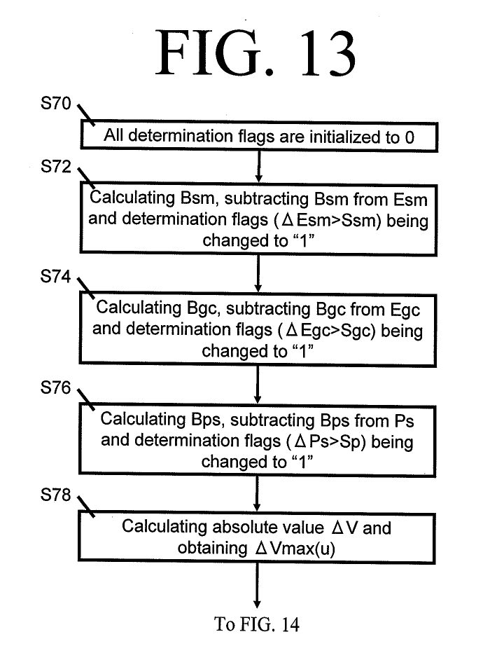

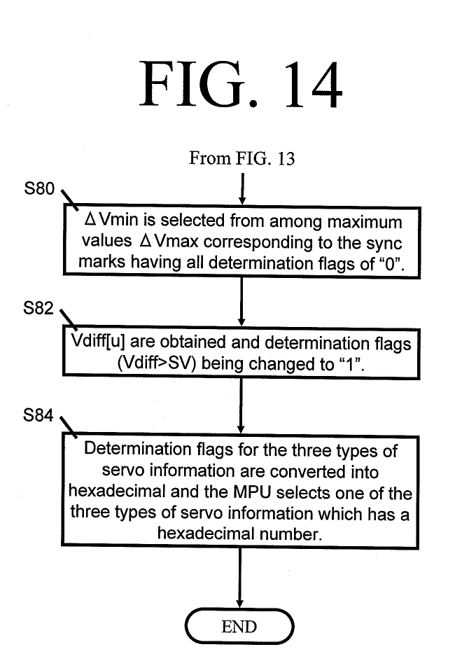

In step S28, when the determination is affirmative, it is determined that the measurements of all the servo-information decryption characteristics using the specified head (for a disc surface) are terminated. Then, the MCU 36 selects pieces of servo information of an optimum type in accordance with results of the measurements. Such an evaluation/selection process will be described below with reference to FIGS. 13 to 15. Then, a bit pattern of a sync mark corresponding to the selected pieces of optimum servo information of the optimum type is stored in an array SAM[HD] in the RAM 38. The MCU 36 increments the head number HD by one so that the head number HD+1 is obtained whereby one of the heads having the next head number is specified.

In step S30, the MCU 36 determines whether the head number HD is larger than a head number HDmax which is a maximum value of the head number (for example, the head number HDmax is “1” when a single magnetic disc is mounted in the device, and the head number HDmax is “3” when two magnetic discs are mounted in the device). When the determination is negative, the process returns to step S22, servo-information decryption characteristics of pieces of servo information corresponding to all servo information numbers are measured, and pieces of optimum servo information are selected in accordance with results of the measurements.

In step S32, when the determination is affirmative, it is determined that the measurements of all the servo-information decryption characteristics using the all heads (for all disc surfaces) are terminated. Accordingly, the MCU 36 stores the selected pieces of optimum servo information in the nonvolatile ROM (not shown) or the system area in the disc medium 10. The selection process is thus terminated.

Then, the selected pieces of optimum servo information are used for positioning the heads, and the read/write test is performed on the disc medium 10. Therefore, pieces of servo information which are not selected are overwritten, that is, removed. Accordingly, the regions other than the regions in which the selected pieces of optimum servo information are written are used as the user data regions.

### Process of Measuring Quality of Servo-Information

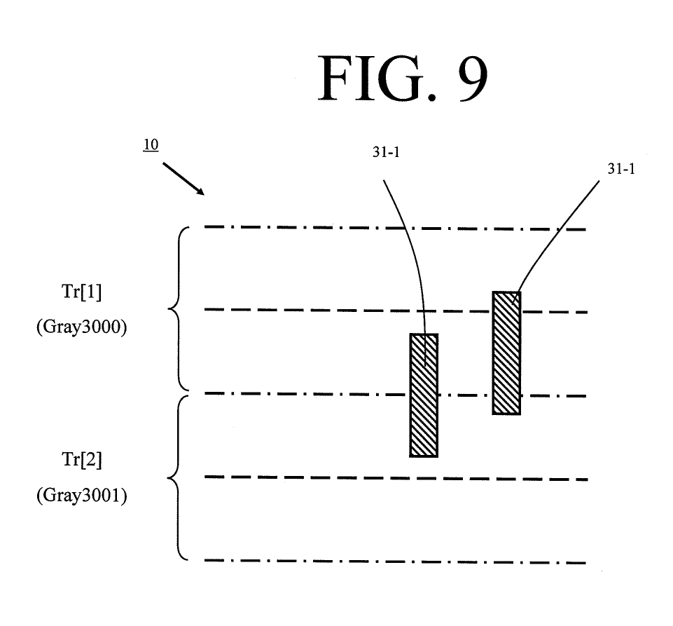

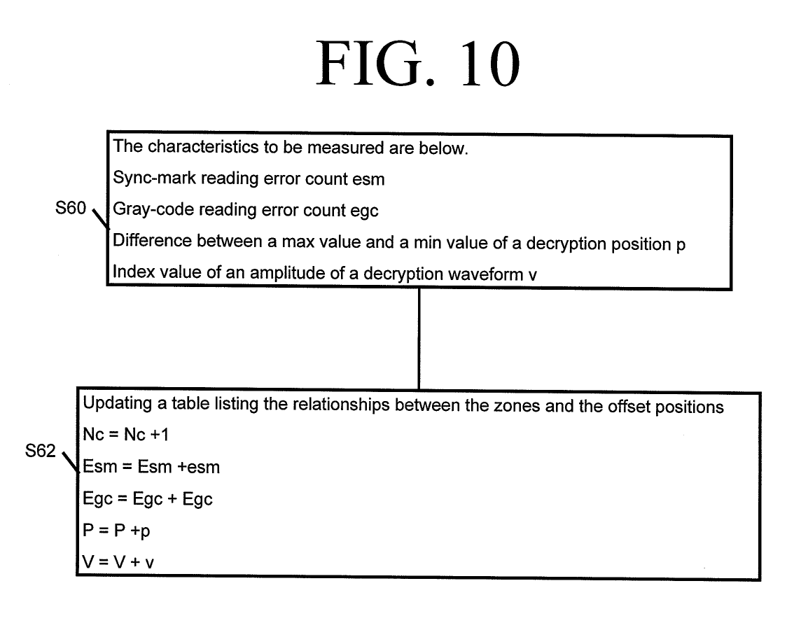

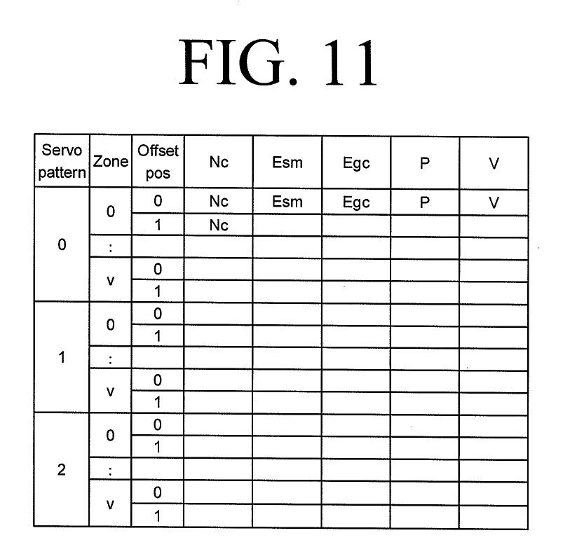

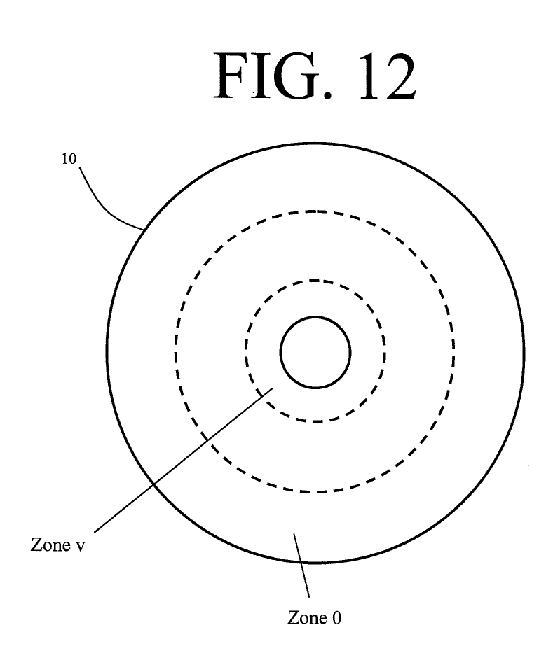

A process of measuring quality of servo-information described in step S24 of FIG. 6A will be described with reference to FIGS. 7A to 12. FIGS. 7A, 7B and 8 are flowcharts illustrating the process of measuring quality of servo-information. FIG. 9 is a diagram illustrating the process of measuring quality of servo-information of FIGS. 7A and 7B performed in offset positions. FIG. 10 is a flowchart illustrating a process of calculating results of the process of measuring quality of servo-information performed in FIG. 8. FIG. 11 is a diagram illustrating a measurement result storing table. FIG. 12 is a diagram illustrating zones which are units of the measurement.

The measurement process of FIGS. 7A, 7B and 8 is described with reference to FIGS. 9 to 12.

In step S40, the MCU 36 assigns “0” to measurement zone information Z. As shown in FIG. 12, the tracks are divided into a plurality of zones 0 to v in a radial direction of the disc medium 10. The process of measuring quality of servo-information is performed for units of zones.

In step S42, the MCU 36 initializes various parameters used in the zone 0. First, the MCU 36 initializes a measurement start track t by assigning T[Z] thereto, a track step count ts by assigning TS[Z] thereto, and a measurement track count tn by assigning TN[Z] thereto.

In step S44, the MCU 36 initializes a parameter of an offset position. That is, the MCU 36 initializes a measuring offset count “to” by assigning TO[Z] thereto. As shown in FIG. 9, before the measurement process is performed on a certain track Tr[1] (which has a gray code of “3000”, for example), a magnetic head (read element) 31-1 is moved to a position displaced from a track center (a corresponding one of dot lines of FIG. 9). In this embodiment, measurement processes are performed by displacing the read element 31-1 from the track center by a quarter track and by a half track so that pieces of servo information are read.

Here, the read element 31-1 is displaced from the track center before the measurement processes are performed since the pieces of servo information of the track Tr[1] to be measured are influenced by pieces of servo information written to an adjacent track (a track Tr[2] in this embodiment). Specifically, in magnetic recording, when a writing operation is performed on a specific track, adjacent tracks are influenced by magnetization intensity of the writing operation of the specific track. In particular, when track pitches are small, the adjacent tracks are considerably influenced by the magnetization intensity. Furthermore, it is difficult to precisely locate the magnetic head 31 in the track center at a time of a reading/writing operation due to environment conditions such as vibration. Accordingly, the process of measuring quality of servo information is preferably performed with the magnetic head 31 displaced from the track center.

In this embodiment, signals are measured in two offset positions so as to evaluate signal qualities (amplitude components, especially) in accordance with relative values obtained by the measurements of the signals. One of the offset positions which is obtained by displacing the read element 31-1 by a quarter track is effectively used when the influence of the writing operation performed on the adjacent track at a side bridge is to be evaluated. The other of the offset positions which is obtained by displacing the read element 31-1 by a half track is effectively used when quality characteristics of the signals at boundary of the track Tr[1] are to be evaluated.

In step S46, the MCU 36 calculates a specific track position (t+ts (tn−1)), and drives the VCM 33 through the SVC 37 so that the read element 31-1 moves to an offset position F[Z]·[tO−1] at the calculated specific track position.

In step S48, the MCU 36 determines whether the read element 31-1 has been moved to the offset position F[Z] [tO−1] by obtaining a positional difference. The movement is determined to fail when position control fails since none of the pieces of servo information in the track Tr[1] is read. When it is determined that the movement has failed, the process proceeds to step S50. On the other hand, when it is determined that the movement has been successfully performed, position decryption characteristics of the track Tr[1] in one full circuit of the disc are measured, and results of the measurements are stored in a measurement result storing area included in the RAM 38. This process will be described in detail with reference to FIG. 10.

In step S50, the MCU 36 decrements the measuring offset count “t0” by one (t0=t0−1). Then, the MCU 36 determines whether the measuring offset count “t0” is equal to or smaller than 0. In FIG. 9, an initial value of the measuring offset count “t0” is 2. When the determination is negative, the process returns to step S46.

On the other hand, when the determination is affirmative in step S50, the measurement processes in the track Tr[1] are terminated, and the process proceeds to step S52 where the measurement track count tn in one of the zones currently processed (hereinafter referred to as a “zone of interest”) is decremented by one (tn=tn−1). Then, the MCU 36 determines whether the updated measurement track count tn is equal to or smaller than “0”. When the determination is negative, the process returns to step S44.

When the determination is affirmative in step S52, the measurement processes have been performed on all the specified tracks in the zone of interest. Accordingly, in step S54, the measurement zone information Z is incremented by one (Z=Z+1). Then, the MCU 36 determines whether the updated measurement zone information Z is larger than a value Zmax which is a maximum value of the measurement zone information Z. When the determination is negative, the process returns to step S42.

When the determination is affirmative in step S54, on the other hand, the measurement processes have performed on all the zones, and the process proceeds to step S56. In step S56, the results of the measurements stored in a measurement result storing area included in the RAM 38 are added to one another and a result of the addition processing is stored in an addition result storing area included in the RAM 38 (which will be described below with reference to FIGS. 10 and 11). The measurement processing performed on one of disc surfaces is thus terminated.

Next, the addition processing will be described with reference to FIGS. 10 and 11.

In step S60, the characteristics to be measured in step S48 include a sync-mark reading error count esm representing the number of errors which occur when the pieces of servo information are read in one full circuit of a disc, a gray-code reading error count egc, a difference p between a maximum value and a minimum value of a decryption position obtained in accordance with a burst signal, and an index value v of an amplitude of a decryption waveform. The read channel circuit 34 shown in FIG. 5 issues a sync-mark found signal to the MCU 36 only when the read channel circuit 34 reads one of the sync marks, and otherwise, the read channel circuit 34 does not issue the sync-mark found signal. Accordingly, the MCU 36 measures the sync-mark reading error count esm by counting sync-mark found signals corresponding to the sync marks included in the pieces of servo information issued in one full circuit of the disc.

Similarly, the read channel circuit 34 issues a gray-code found signal to the MCU 36 only when the read channel circuit 34 reads one of the gray codes, and otherwise, the read channel circuit 34 does not issue the gray-code found signal. Accordingly, the MCU 36 measures the gray-code reading error count egc by counting gray-code found signals corresponding to the gray codes included in the pieces of servo information issued in one full circuit of the disc.

A difference between the decryption position obtained by decrypting the burst signal using the read channel circuit 34 and a target position is calculated using the MCU 36 every time the burst signal is decrypted using the read channel circuit 34, a maximum value and a minimum value of the decryption position in one full circuit of the disc are obtained, and a difference p between the maximum value and the minimum value is calculated.

Furthermore, the index value v of amplitude of a decryption waveform is associated with gains of an AGC (Automatic Gain Control) circuit included in the read channel circuit 34. The gains are automatically controlled so as to be used to read the pieces of servo information. Then, the MCU 36 reads the gains from the read channel circuit 34, and obtains an average of the gains for one full circuit of the disc as the index value v.

In step S62, the MCU 36 updates a table listing the relationships between the zones and the offset positions using the results of the calculations performed in step S60. Specifically, as shown in FIG. 11, an addition result table includes types of servo information (servo patterns), the offset positions (0 denotes 0.25 track, and 1 denotes 0.5 track) in the zones 0 to v, measurement cylinder counts, sync-mark reading error counts esm, gray-code reading error counts egc, integrated values of differences p each of which is a difference between a maximum value and a minimum value of a decryption position obtained in accordance with a burst signal, and an integrated value V of index values v each of which is an index value of an amplitude of a decryption waveform, which are calculated for individual offset positions in the zones 0 to v. Accordingly, after the offset positions are measured in the zone of interest in accordance with the flowcharts of FIGS. 7A, 7B and 8, the MCU 36 performs addition processes on measurement cylinder counts Nc, on the sync-mark reading error counts esm, on the gray-code reading error counts egc, on the positional differences p, and on the index value v of an amplitude of a decryption waveform for the zone of interest and for each of the offset positions in the zone of interest, and the table is updated using results of the addition processes.

As described above, the measurement processes are performed on the pieces of servo information in accordance with the flowcharts of FIGS. 7A, 7B and 8, and consequently, the table representing decryption qualities of the pieces of servo information obtained in individual offset positions is obtained as shown in FIG. 11.

### Servo-Information Evaluation/Selection Process

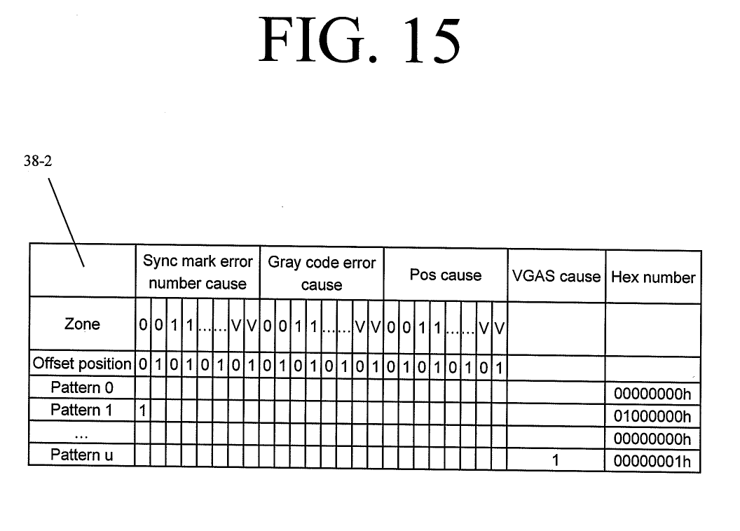

Referring to FIGS. 13 to 15, the process of selecting one of a plurality of types of servo information after qualities of pieces of servo information are evaluated in accordance with the results of the measurements obtained through the processes described with reference to FIGS. 7A to 12 will now be described. Note that FIGS. 13 and 14 show flowcharts illustrating the process of selecting one of a plurality of types of servo information. FIG. 15 is a diagram illustrating a determination flag table used in the process of selecting one of a plurality of types of servo information described with reference to FIGS. 13 and 14.

In step S70, all determination flags included in a determination flag table 38-2 shown in FIG. 15 included in the RAM 38 are initialized to 0. Note that the determination flag table 38-2 includes determination flags regarding sync mark error factors, gray code error factors, Pos factors, and VGAS factors, for individual pieces of servo information (patterns 0 to u). As for the sync mark error factors, the gray code error factors, and the Pos factors, determination flags are assigned for individual offset positions included in individual zones.

In step S72, the MCU 36 calculates minimum values Bsm of sync-mark reading error counts esm of all offset positions of all the zones shown in FIG. 11, subtracts the minimum values Bsm from the corresponding sync-mark reading error counts esm so as to obtain values ΔEsm. Then, the values ΔEsm of all the offset positions in all the zones are compared with a predetermined threshold value Ssm. In accordance with the comparison, determination flags, among all the determination flags, corresponding to offset positions of zones corresponding to values ΔEsm larger than the threshold value Ssm are changed to “1”. That is, evaluation is performed using a relative value while taking an error into consideration. Specifically, minimum values are obtained, the numbers of sync mark errors are converted into certain values on the basis of the minimum values, and when the certain values are larger than a threshold value, the determination flags are changed to “1” representing a low grade.

In step S74, the MCU 36 calculates minimum values Bgc of gray-code reading error counts egc of all the offset positions in all the zones shown in FIG. 11, subtracts the minimum values Bgc from the corresponding gray-code reading error count egc so as to obtain values ΔEgc. Then, the values ΔEgc of all the offset positions in all the zones are compared with a predetermined threshold value Sgc. In accordance with the comparison, determination flags, among all the determination flags, corresponding to offset positions of zones corresponding to values ΔEgc larger than the threshold value Sgc are changed to “1”. That is, evaluation is performed using a relative value. Specifically, minimum values are obtained, the numbers of gray code errors are converted into certain values on the basis of the minimum values, and when the certain values are larger than a threshold value, the determination flags are changed to “1” representing a low grade.

In step 76, the MCU 36 calculates minimum values Bps of integrated values Ps of decryption positions of all the offset positions in all the zones shown in FIG. 11, subtracts the minimum values Bps from the corresponding integrated values Ps of decryption positions so as to obtain values ΔPs. Then, the values ΔPs of all the offset positions in all the zones are compared with a predetermined threshold value Sp. In accordance with the comparison, determination flags, among all the determination flags, corresponding to offset positions of zones corresponding to values ΔPs larger than the threshold value Sp are changed to “1”. That is, evaluation is performed using a relative value. Specifically, minimum values are obtained, integrated values of decryption positions are converted into certain values on the basis of the minimum values, and when the certain values are larger than a threshold value, the determination flags are changed to “1” representing a low grade.

In step S78, the MCU 36 calculates absolute values ΔV of values obtained from differences between integrated values (average values) of the offset positions 0 and integrated values (average values) of the corresponding offset positions 1 in the individual zones shown in FIG. 11. Then, among the absolute values ΔV obtained for the individual zones including a number u+1 (three, in this embodiment) of types of servo information, a maximum value ΔVmax[0], a maximum value ΔVmax[1], and a maximum value ΔVmax[2] which are maximum values for the corresponding types of servo information are obtained. The maximum values ΔVmax represent degrees of influences of deviations between adjacent pieces of servo information generated when servo track writing (STW) operations are performed.

In step S80 of FIG. 14, a minimum value ΔVmin is selected from among maximum values ΔVmax corresponding to the sync marks having all determination flags of “0”.

In step S82, the minimum value ΔVmin is subtracted from each of the maximum values ΔVmax[u] of the three types of servo information so that certain values Vdiff[u] are obtained. Then, each of the values Vdiff of three types of servo information is compared with a threshold value Sv, and when it is determined that one of the values Vdiff is larger than the threshold value Sv, determination flags corresponding to the one of the values Vdiff for a corresponding one of the three types of servo information are turned to “1”. That is, the degrees of influences of deviations between adjacent pieces of servo information are determined in accordance with the maximum values obtained using the differences of amplitudes in pairs of offset positions, and the maximum values are converted into certain values on the basis of a minimum value, and when the certain values are larger than a threshold value, the determination flags are changed to “1” representing a low grade.

In step S84, the determination flags for the three types of servo information in the determination flag table 38-2 are converted into hexadecimal numbers having high-order bits on the left sides thereof and low-order bits on the right sides thereof. The MCU 36 selects one of the three types of servo information which has a minimum hexadecimal number among the converted hexadecimal numbers. After one of the bit patterns of the sync marks corresponding to the one of the three types of servo information is stored in the system area included in the disc, the process is terminated.

As is apparent from the determination flag table 38-2 shown in FIG. 15, the most important factor for selecting one of the three types of servo information is the number of sync marks successfully read, followed by the number of gray codes successfully read, positional accuracy, and an amplitude factor. If the determination of the selection is performed using absolute values, no type of servo information may be selected, and accordingly, even if qualities of pieces of servo information included in only one specific track are poor, it is determined that qualities of all the pieces of servo information are poor. Therefore, the evaluations are performed using relative values so that one of the three types of servo information is selected. If one of pieces of servo information of the selected one of the three types of servo information is deteriorated, only a track including the deteriorated one of the pieces of servo information is determined to be not available.

Note that if a plurality of types of servo information have identical minimum hexadecimal values, one of the plurality of types of servo information having the smallest pattern number is selected.

### Process of Using Servo-Information:

As described in step S16 of FIG. 1, in a case where one of the sync mark patterns corresponding to the optimum type of servo information is stored in the system area of the disc medium 10, when the disc device 30 is first turned on after being shipped, information on the one of the sync mark patterns corresponding to the optimum type of servo information is not read. Therefore, the one of the sync mark patterns to be used to read the pieces of servo information of the optimum type is unknown.

Accordingly, the nonvolatile ROM includes a table listing a plurality of types of sync mark patterns stored in advance. When each of the heads is loaded and one of the sync mark patterns is read, a sync-mark setting value of a read channel is successively replaced by a value read from the table listing the sync mark patterns whereby the pieces of servo information of the optimum type are read.

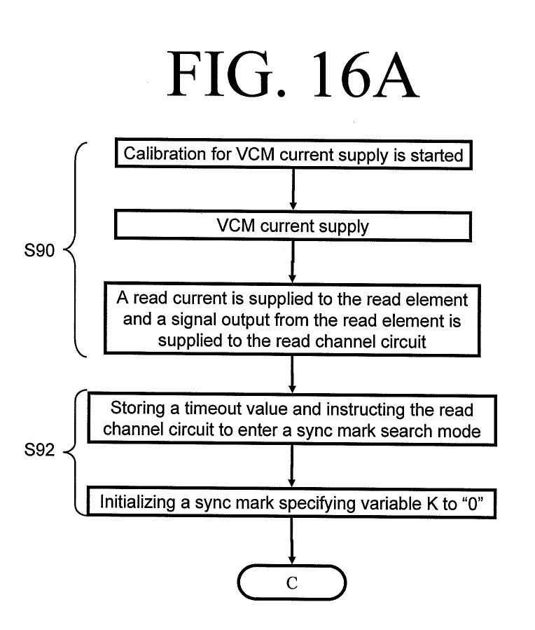

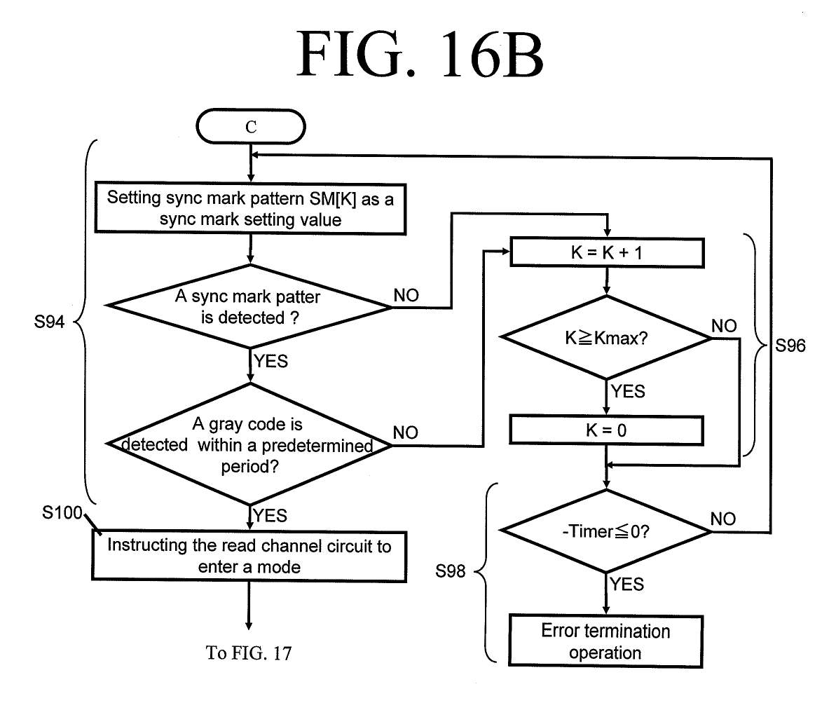

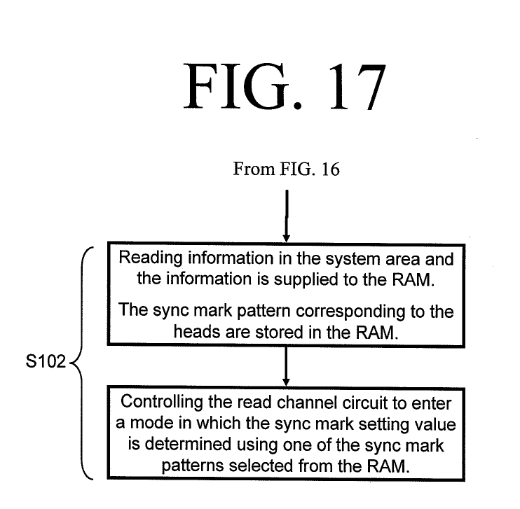

FIGS. 16A, 16B and 17 are flowcharts illustrating a process of using selected pieces of servo information according to the embodiment of the present technique.

In step S90, calibration for VCM current supply is started. The term “VCM current supply” means the following operation. When the magnetic head 31 does not perform a reading/writing operation, the magnetic head 31 is parked in a land outside of the magnetic disc. When the disc device is turned on to be used, the magnetic head 31 is moved from the land to be loaded onto the disc medium 10. Here, since the one of the sync mark patterns corresponding to the optimum type of servo information has not yet been read, the position control can not be performed on the magnetic head 31. Therefore, the magnetic head 31 is moved from the land to be loaded onto the disc medium 10 after a predetermined current is supplied to the VCM 33 (VCM current supply). Then, a read current is supplied to the read element 31-1 of the magnetic head 31. A signal output from the read element 31-1 is supplied to the read channel circuit 34.

In step 92, the MCU 36 stores a timeout value in a variable timer before activating the variable timer. Furthermore, the MCU 36 instructs the read channel circuit 34 to enter a sync mark search mode. Thereafter, the MCU 36 initializes a sync mark specifying variable K to “0”.

In step S94, the MCU 36 sets sync mark pattern SM[K] as a sync mark setting value, where K denotes the sync mark specifying variable, and supplies the sync mark setting value to the read channel circuit 34. The read channel circuit 34 searches the signal output from the read element 31-1 for one of the sync mark patterns in accordance with the instruction of the sync mark search mode and the sync mark setting value. When detecting the one of the sync mark patterns, the read channel circuit 34 notifies the MCU 36 of the detection of the one of the sync mark patterns. In a case where the MCU 36 does not receive any notification, the MCU 36 determines that the one of the sync mark patterns has not been detected, and the process proceeds to step S96. On the other hand, when receiving the notification of detection of the one of the sync mark patterns, the MCU 36 determines whether the read channel circuit 34 has detected a gray code corresponding to the one of the sync mark patterns within a predetermined period after the one of the sync mark patterns is detected. When the determination is negative, the process proceeds to step S96.

In step S96, the MCU 36 increments the sync mark specifying variable K by one (K=K+1), that is, the next sync mark pattern is specified. Thereafter, it is determined whether the sync mark specifying variable K is equal to or larger than a maximum value Kmax. When the determination is affirmative, “0” is assigned to the sync mark specifying variable K, which is an initial value.

In step S98, the MCU 36 determines whether time has run out using the timer. Since the time out value has been set to the timer for the sync mark search mode, when the determination is affirmative, the MCU 36 enters an error termination operation. That is, the error termination operation is performed since none of the sync mark patterns is detected within the predetermined period. On the other hand, when the determination is negative, the process proceeds to step S94, and the remaining next sync mark patterns are searched for.

When the MCU 36 determines that the read channel circuit 34 has detected a gray code corresponding to the one of the sync mark patterns within a predetermined period after the one of the sync mark patterns is detected in step S94, the process proceeds to step S100 where the MCU 36 instructs the read channel circuit 34 to enter a mode in which the pieces of servo information corresponding to the one of the sync mark patterns are decrypted with predetermined intervals.

In step S102, since the pieces of servo information are allowed to be decrypted, the MCU 36 drives the VCM 33 through the SVC 37 so that the magnetic head 31 is positioned in the system area (for example, the inner circumference side) of the disc medium 10. The MCU 36 controls the magnetic head 31 to read information in the system area, and the information is supplied to the RAM 38. As described above, since the sync mark patterns corresponding to the heads are stored in corresponding system areas, the sync mark patterns corresponding to the heads are stored in the RAM 38. Therefore, when selecting one of the heads, the MCU 36 controls the read channel circuit 34 to enter a mode in which the sync mark setting value is determined using one of the sync mark patterns selected from the RAM 38.

In this way, the sync mark patterns (selected pieces of servo information) for the heads are stored in the system areas of the discs. Even in a case where a sync mark pattern to be used to read one of the system areas is unknown, when each of the heads are loaded and one of the sync mark patterns is read, a sync-mark setting value of a read channel is successively replaced by a value read from the table listing the sync mark patterns whereby the pieces of servo information of the optimum type are read.

Even in a case where a plurality of heads are used, sync mark patterns for the plurality of heads are automatically set by this reading operation, that is, optimum sync mark patterns for all the heads can be obtained by performing the sync mark search operation on one of the heads.

### Other Embodiments

In the forgoing embodiment, the qualities of the pieces of servo information is evaluated using four types of factor, that is, the sync mark patterns, the gray codes, the position decryption characteristics, and the amplitude characteristics. However, the qualities may be evaluated using some of them. For example, only two items, i.e., the sync mark patterns and gray codes may be used, or only three items, i.e., the sync mark patterns, gray codes, and position decryption characteristics may be used. Furthermore, although in the forgoing embodiment, the three types of servo information are written to the disc, two types of servo information or four or more types of servo information may be written to the disc. Similarly, although the writing parameters correspond to current values in the forgoing embodiment, the writing parameters may correspond to other parameters such as frequencies.

In the forgoing embodiment, the qualities are evaluated using firmware programs of the MCU 36 included in the disc device. However, an external evaluation device connected to the disc device may be used to measure and evaluate the qualities, and in accordance with results of the measurements and the evaluations, the MCU 36 may select one of the plurality of types of servo information. Furthermore, an oscilloscope may be used for monitoring the amplitude measurements.

Furthermore, although the magnetic disc is taken as an example of the disc medium in the forgoing embodiment, any storage medium which uses another type of servo information may be employed. A method for magnetically transferring pieces of servo information to a disc medium or a method for writing pieces of servo information after a disc medium is incorporated in a disc device (device servo track writing or self servo writing) may be employed as the operation of writing the pieces of servo information.

Note that the nonvolatile RAM may be used for storing a selected one of the plurality of servo information therein. In this case, the sync mark search process described with reference to FIGS. 16A, 16B and 17 is eliminated.

The embodiments of the present technique are described hereinabove. However, the present technique is not limited to these and various modifications may be made within a scope of the present technique.

What is claimed is:

1. A disc apparatus comprising:
a medium being capable of storing data and including a plurality of sets of servo information, each set of the servo information having identification information;
a head for writing data into and reading data from the medium;
an actuator for supporting the head; and
a controller for controlling the actuator in reference to selected one of the sets of the servo information on the basis of the associated identification information so as to move the head to a target position of the medium.

2. The disc apparatus of claim 1, wherein the controller decrypts the plurality of sets of servo information read by the head and selects the one of the plurality of sets of servo information by measuring decryption qualities of the plurality of sets of servo information.

3. The disc apparatus of claim 1, wherein the controller uses regions other than regions to which the selected one of the plurality of sets of servo information is written in the medium as user data regions.

4. The disc apparatus of claim 1, wherein the controller detects the selected one of the plurality of sets of servo information from a signal outputted from the head before reading and writing operations are performed.

5. The disc apparatus of claim 2, wherein the controller measures at least decryption error rates as the decryption qualities.

6. The disc apparatus of claim 1, wherein the controller stores the selected one of the plurality of sets of servo information including the identical formats and different sync mark patterns.

7. A method of storing servo information on a disc medium comprising:
writing a first set of servo information on the disc medium;
writing data into and reading data from the disc medium by a head which is positioned in reference to the first set of servo information;
determining read write characteristic when the first set of servo information is used;
writing a second set of servo information on the disc medium;
writing data into and reading data from the disc medium by the head which is positioned in reference to the second set of servo information;
determining read write characteristic when the second set of servo information is used; and
determining either one of first and second sets of servo information to be remained on the disc medium on the basis of the read write characteristics.

8. The method of claim 7, wherein the first set of servo information and the second set of servo information have identical formats and being written into the disc medium on the basis of different parameters and further comprising decrypting the first set of servo information and the second set of servo information, measuring qualities of the decrypted servo information and wherein the determining determines on the basis of evaluating the measured qualities of the decrypted servo information.

9. The method of claim 8, further comprising writing a plurality of sets of servo information into the disc medium, each of the plurality of sets of servo information having a different parameter.

10. The method of claim 8, wherein the measuring measures at least decryption error rates.

11. The method of claim 8, wherein the measuring measures at least decryption error rates and positioning accuracies.

12. The method of claim 9, wherein the writing writes the plurality of sets of servo information on the basis of a different current.

13. The method of claim 9, wherein the writing writes the plurality of sets of servo information having identical formats on the basis of different parameters.

14. The method of claim 11, wherein the determining determines in accordance with the results of evaluations of qualities of the plurality of sets of servo information, and the decryption error rates are more important factors than positioning accuracies.

15. The method of claim 8, wherein the determining determines on the basis of relatively evaluating the measured decryption qualities of the first set of servo information and the second set of servo information.

16. A disc medium for being read by a head comprising:
a plurality of types of servo information for positioning the head, each of the plurality of types of the servo information being written to thereto with different writing parameters and being identical formats.

17. The disc medium of claim 16, wherein each of the plurality of types of servo information having a sync mark pattern, respectively.

18. The disc medium of claim 16, wherein each of the plurality of types of servo information having at least a preamble, a sync mark pattern, a gray code and a burst signal.
